(19) United States
(12) Patent Application Publication
(10) Pub. No.: US 2012/0245401 A1
(43) Pub. Date: Sep. 27, 2012

(54) PROCESSING MINE TAILINGS

(75) Inventors: Jason C. Holmberg, Coudersport, PA (US); Luke E. Watson, Coudersport, PA (US)

(73) Assignee: BioMaxx, Inc., Wellsville, NY (US)

(21) Appl. No.: 13/069,367

(22) Filed: Mar. 22, 2011

(51) Int. Cl. C02F 11/12

(52) U.S. Cl. 588/256; 588/249

(57) ABSTRACT

A method for processing mine tailings includes introducing a volume of dried densified biomass products to mine tailings to produce a conglomerate mixture having substantially no liquid.

### BACKGROUND OF THE INVENTION

1. Technical Field

The present invention relates to oil and natural gas recovery. More specifically, the invention relates to treating tailings resulting from natural gas drilling in areas consisting predominately of shale.

2. Description of Related Art

Drilling wells to extract natural gas from shale, especially the Marcellus Shale, presents unique challenges. For example, drilling and hydro fracturing the shale to recover the natural gas requires large amounts of water. This water, along with any additional chemicals, by-products and debris used in or resulting from the drilling process, comprise tailings that must be removed from the formed gas well before gas can be extracted.

Historically, the resultant tailings could be pumped out of the well and deposited into an onsite dumping pond or the like, and left when the well was abandoned. However, regulatory agencies and local governments now regularly require that these mine tailings be removed from the drill site, and deposited in landfills.

The tailings, however, are not readily transportable. The tailings tend to be too liquid for dump trucks, and usually include too much sediment and debris for shipping by tanker truck. At least one prior method to prepare the tailings for transport was to use “hot lime,” which would substantially solidify the tailings through an exothermic reaction. This process, however, is generally disfavored, because the exothermic reaction causes caustic emissions of carcinogenic contaminants and can cause fires under some conditions. In drier climates, the tailings can be left in open containers to let the moisture evaporate, leaving only solids that can subsequently be disposed of through conventional channels. However, this evaporation takes time, and is not practical in all climates, especially those with higher humidity, such as is prevalent in the Marcellus Shale region.

Thus, there is a need in the art for a method of treating mine tailings to facilitate easier transport using conventional methods.

### SUMMARY OF THE INVENTION

The present disclosure addresses the foregoing need in the art by providing a method and composition for treating mine tailing.

In one aspect of the disclosure, a method of treating mine tailings includes adding a sufficient amount of dried densified biomass products to mine tailings to produce a conglomerate mixture having a slump of at least one. The dried densified biomass products may include a plurality of crumbled wood pellets.

In another aspect of the disclosure, a conglomerate mixture includes dried densified biomass products as a plurality of densified wood pellets and shale tailings. In other embodiments, the mixture may have a pH value below seven and/or a slump of at least one.

Another aspect of the disclosure provides a method of handling a mine tailing conglomerate mixture. The method includes transporting the conglomerate mixture from a first location to a second location remote from the first location. The conglomerate mixture includes dried densified biomass products mixed with shale tailings. The conglomerate mixture is characterized by a slump greater than or equal to approximately one and a pH value less than or equal to approximately seven.

These and other aspects, features, and benefits of the invention may be had with reference to the following disclosure and accompanying figures, in which embodiments of the invention are described and shown.

### BRIEF DESCRIPTION OF THE DRAWING FIGURES

FIG. 1 is a flow chart illustrating a process for processing mine tailing according to the present invention.

### DETAILED DESCRIPTION OF THE INVENTION

The present invention relates to a composition and a method for treating mine tailings for transportation. The composition and method are usable with any mine tailings having high liquid content, but are particularly well suited for shale tailings resulting from shale drilling and hydrofracing such as in the Marcellus Shale.

Mine tailings are a byproduct of drilling to extract resources, such as natural gas, from the earth. In conventional methods for drilling wells, including hydrofracing, a large amount of highly pressurized water is used to aid in breaking through rocks, such as shale. The water must be removed from the well before extraction of the natural resources can take place. The extracted water contains debris from the drilling, and because of its close contact with the underground rock, also may include brines, radionuclides, heavy metals, and organics. This extracted material, referred to as tailings or mine tailings, in many applications must be disposed of at a landfill or similar site.

As discussed above, because of the high water content, handling mine tailings can be very difficult.

In one configuration, a dried densified biomass product is added to the tailings in a sufficient amount to absorb a significant amount of the water. In an embodiment, the dried densified biomass product is added to the tailings in an amount sufficient to produce a conglomerate mixture, including the dried densified biomass product and the tailings, having substantially no liquid content.

According to one embodiment, the dried densified biomass product is a densified wood product, such as wood pellets. The wood pellets are formed using conventional techniques from logging waste including chips, green sawdust, slabs, edgings and end-trim. In production the logging waste is dried, for example, in the presence of heat. The dried waste is then processed to make substantially uniformly sized, relatively small particles. These particles typically have a size of approximately ¼″-. These particles are then extruded through a high-pressure extruder and cut off, usually at regular intervals to form the pellets or are pressed into a desired size and shape. The processed pellets preferably are substantially uniform in substance, density and size. The processed pellets are preferably characterized as having a water content of less than about 8%-10% and more preferably about 5%. The processed pellets are generally cylindrical, having a length of from about 1 inch to about 2 inches and a diameter of about one-eighth of an inch to about five-eighths of an inch. The density of the dried densified biomass products, such as pellets, is between approximately 25 and 45 pounds per cubic foot. While the present configuration is set forth in terms of cylindrical pellets, it is understood the pellets could be of other sizes and shapes.

These dried densified biomass products are conventionally used in pellet stoves, where they are burned to generate heat. However, it has been found that the pellets or other dried densified biomass products, because of their relatively low water content, are unexpectedly effective at absorbing the large amounts of water contained in mine tailings. Moreover, the pellets are readily available, easy to handle and efficient. Based on preliminary tests, the dried densified biomass products, such as pellets, are approximately five times more effective at absorbing moisture from mine tailings than green sawdust and twice as effective as hydrated lime.

It has been found that adding dried densified biomass having approximately 5-8% water content to shale tailings in a ratio of between about 1:2 and 1:4 can produce a conglomerate mixture in which about 90% of the moisture in the extracted tailings is absorbed in about five minutes. Within about thirty-five minutes, substantially all of the moisture will be absorbed. Specifically, after about thirty-five minutes, there is substantially no liquid seeping or otherwise flowing from the conglomerate mixture.

Besides being effective, use of the dried densified biomass products has other benefits. Use of the dried densified biomass products does not have the dust emissions common with sawdust or the accompanying caustic byproducts associated with hydrated lime. Moreover, the amount of material required to be shipped to the site is lowered, because relatively less material is needed than with sawdust or hydrated lime.

For example to render 10 yards of mine tailing transportable, approximately 10 to 20 yards of green sawdust or 5 to 10 yards of hydrated lime would be required. In contrast, approximately 2.5 to 5 yards of dried densified biomass products is required to render the 10 yards of mine tailings transportable.

In turn, fewer trucks are required to carry the dried densified biomass products to the site and to carry away the conglomerate mixture. This results in decreased fuel consumption, road wear and truck use.

Although the dried densified biomass products may be mixed directly with the tailings and will absorb water, when used as pellets, the pellets are preferably further processed by crumbling or crushing. Specifically, the pellets may be processed with a grinder, chipper or other mechanical means to break down the pellets into smaller pieces, thereby effectively increasing the overall surface area of the pellets. In one embodiment, the pellets are passed through a crumbler having spaced-apart rollers. The distance between the rollers preferably is slightly less than the diameter of the pellets. The rollers may be spaced between about one-eighth of an inch and three-eighths of an inch. The crumbled pellets have a density of approximately 25 to 40 pounds per cubic foot and more preferably about 30 pounds per cubic foot. The crumbled pellets, or other dried densified biomass products, range in size from about one-eighth to about five-eighth inch in effective diameter. During crumbling, the pellets will generally crumble or separate at weaknesses created during the pellet formation process. Specifically, when the dried raw material is pressed and/or extruded into pellets, the fibers in the component raw materials are bonded together in the presence of heat and pressure, for example, when fibers or lignin melt or at least soften sufficiently to be mechanically bonded or fused together. Some of these bonds will be weaker than others. The crumbling process preferably results in breaking these bonds, for example by breaking the lignin barrier formed during pressurization. Alternatively, the crumbling process may just break up the pellets using mechanical forces. Whatever the crumbling method, the crumbled pellets have an increased surface area compared to the generally cylindrical pellets and, in some embodiments, the lignin barrier is broken down. More of the pellet is thus exposed to the moisture and is available for absorption.

In crumbling methods just described, the resultant crumbled pellets are generally not uniform in size or shape. In other embodiments, the pellets could be cut using a saw or similar apparatus, resulting in a more uniformly sized and shaped product. In these embodiments, the resultant particles still are reduced in size compared to the original pellet, thus having a greater surface area. Such methods may not be as effective at thoroughly breaking the lignin barrier.

According to one configuration, the crumbled pellets, dried densified biomass products, are mixed with the mine tailings to absorb the water contained in the tailings. Preferably, a sufficient amount of dried densified biomass products as crumbled pellets is provided to the tailings to create a resultant mixture having substantially no liquid. In examples conducted by the inventors, the crumbled pellets were introduced to the tailings in a ratio between approximately 1-to-2 and 1-to-4. In about three minutes, 90% of the liquid in the tailings is absorbed with the remaining being absorbed over the next about thirty minutes. The composition of the conglomerate mixture is preferably such that substantially no liquid is present. In one embodiment, water content is such that less than about 10 gallons of liquid water remains unabsorbed per 30 yards of conglomerate mixture after one hour, and preferably less than about 2 gallons of liquid water remains unabsorbed. Moreover, it is preferred that less than about 1 gallon of liquid water seep from the conglomerate mixture in about an hour. The composition of the resultant mixture is preferably that composition accepted by the landfill or other waste processing facility to which the tailings are to be delivered. In most applications, the composition should be as close to the composition accepted by the facility, to optimize the amount of dried densified biomass products required.

The addition of the dried densified biomass products such as pellets, whether or not crumbled, to the mine tailings also preferably maintains a pH of below about 7 for the conglomerate mixture. Because the tailings are alkaline and dried densified biomass products are neutral, the pH of the conglomerate mixture will be closer to neutral than the tailings alone. This is distinct from conventional processes using hydrated lime, which result in increased pH levels, sometimes above about 12. Increased pH levels, especially above 12, may be unacceptable at some disposal facilities, for example, because of their potential effect on drinking water or the like. Additives also may be introduced into the mixture to control the pH.

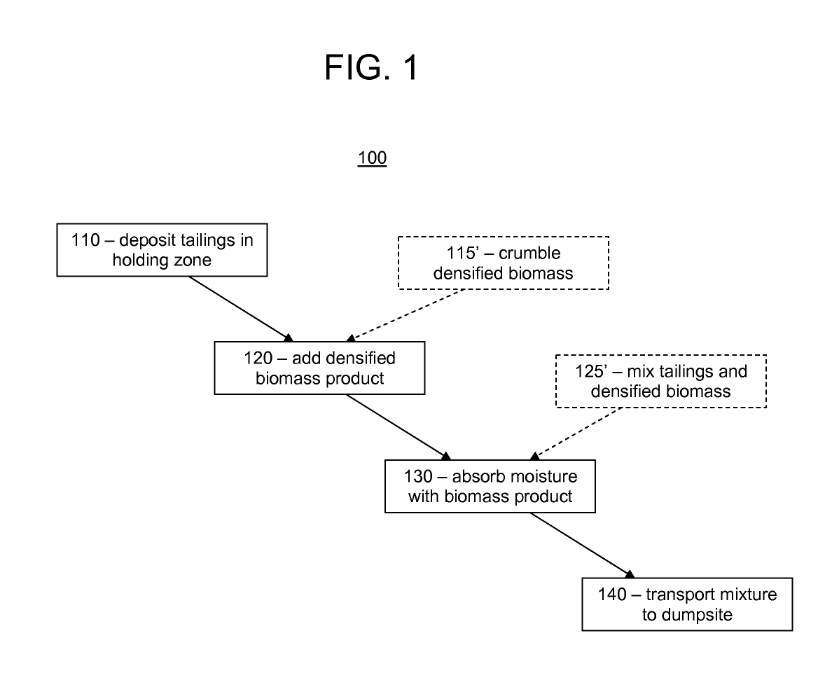

A process 100 for treating the tailings now will be described in more detail with reference to FIG. 1. Upon completion of a drilling process for forming a well, the tailings are extracted from the well using conventional equipment, such as pumps. In step 110, the extracted tailings are deposited into a holding zone, such as a truck, vessel, tank, reservoir or pond. A quantity of dried densified biomass products is thereafter added to the tailings in the vessel in step 120. In step 130, the biomass absorbs moisture in the tailings to create a conglomerate having a higher viscosity than the original, substantially liquid extraction. The biomass is added to create a conglomerate mixture having a ratio of densified biomass products to tailings of from about 1-to-2 to about 1-to-4. Once water is sufficiently absorbed, generally after about 30 to 60 minutes, the mixture can be transported by dump truck or other conventional machine to a landfill or appropriate dumpsite in step 140. Further, the pH of the conglomerate is typically between approximately 7.0 to 8.5 as compared to the mine tailings, which have a pH of between approximately 9.0 and 12.0.

As described above, and as illustrated in optional step 115′, the dried densified biomass products may be crumbled prior to introduction into the holding zone.

The process may also include a mixing step 125′ to disperse the dried densified biomass products within the tailings, further increasing the absorption rate. The dried densified biomass products may be manually mixed into the tailings or a mechanical mixer can be used, generally depending upon the amount of tailings to be processed. For example, a cement mixer could be used to mix the dried densified biomass products and tailings. The liquid in the holding zone could be circulated, for example, using a pump. In the field, an excavator with a bucket may be used to scoop the tailings and dried densified biomass products into a container such as a 30-yard garbage container. The bucket also may be used to mix the tailings and the dried densified biomass product in the container. As required, the excavator bucket also could remove the conglomerate mixture after mixing, once substantially all of the liquid has been absorbed. Other mixing apparatus are known, and could be used to mix the tailings and the dried densified biomass products.

As another optional step, the method may also include a measuring step, which may include measuring one or more of the weight, composition, and volume of the mine tailings. With this measurement, an appropriate amount of dried densified biomass products may then be introduced to form the conglomerate mixture. The measuring step also may include measuring the amount of dried densified biomass products, again, to optimize the ratio of tailings to dried densified biomass products, or more specifically, the ratio of moisture content in the tailings to the dried densified biomass products.

In an alternative embodiment, the dried densified biomass products is pre-placed into the holding zone, with the tailings thereafter being deposited onto the dried densified biomass products. The order of the steps is not essential, although mixing is likely more easily carried out when the solid is added to the liquid. In yet another embodiment, the tailings and dried densified biomass products could be introduced into the holding zone substantially simultaneously.

When the dried densified biomass products as pellets are crumbled or otherwise reduced in size, the increased surface area will result in faster absorption. Thus, processing time, that is, absorption time, can be minimized. In this manner, to the extent the tailings contain any noxious chemicals, the time at which they are contained at the drill site is reduced. In the instance of noxious chemicals, the system may also be substantially closed. That is, the tailings may be extracted from the well and immediately disposed in a substantially closed vessel. In this closed vessel, the dried densified biomass products is mixed with the tailings. The conglomerate mixture is thereafter pumped or otherwise conveyed to a vessel for shipping, such as a dump truck.

The holding zone in which the tailings and dried densified biomass products are mixed may also be a controlled environment. Specifically, it may be pressure, humidity, and/or temperature controlled.

Modifications to the invention also are contemplated. For instance, although the foregoing embodiments were generally described with reference to pellets made from wood, this is not required. The pellets may be made from any densified biomass product, including those made of switch grass, bagasse or any other fibrous cellulosid binder having low water content. Other moisture absorbing compositions also may be used, including but not limited to silica gel, clay-based absorbers, and calcium chloride.

The foregoing embodiments of the present invention are provided as exemplary embodiments and are presently best modes for carrying out the invention. Modifications of these embodiments will be readily apparent to those of ordinary skill in the art. The invention is not intended to be limited by the foregoing embodiments, but instead is intended to be limited only by the appended claims.

1. A method of treating mine tailings, comprising:
adding a sufficient amount of dried densified biomass products to the mine tailings to produce a conglomerate mixture having substantially no liquid.

2. The method of claim 1, wherein the dried densified biomass products comprises a plurality of crumbled wood pellets.

3. The method of claim 1, wherein the mine tailings comprise shale tailings.

4. The method of claim 1, further comprising reducing a pH value of the conglomerate mixture below a predetermined level.

5. The method of claim 4, wherein the predetermined level is approximately seven.

6. A conglomerate mixture, comprising:
a mass of dried densified biomass products and shale tailings.

7. The mixture of claim 6, wherein the conglomerate mixture has a pH value below approximately seven.

8. The mixture of claim 6, wherein the conglomerate mixture has substantially no liquid.

9. A method of handling a conglomerate mixture of mine tailings and dried densified biomass products, comprising:
transporting the conglomerate mixture from a first location to a second location remote from the first location, wherein the conglomerate mixture comprises a mass of dried densified biomass products and the shale tailings,
the conglomerate mixture being characterized by seeping less than about 1 gallon of water per hour per 30 yards of conglomerate mixture and a pH value less than or equal to approximately seven.

10. The method of claim 9, wherein transporting the conglomerate mixture comprises removing the conglomerate mixture from a holding zone where the dried densified biomass products and the shale tailings are comingled.

11. The method of claim 10, wherein transporting the conglomerate mixture comprises loading the conglomerate mixture onto a work machine.

12. The method of claim 11, wherein the work machine comprises a mining vehicle.
